(19) United States
(12) Patent Application Publication
(10) Pub. No.: US 2023/0288138 A1
(43) Pub. Date: Sep. 14, 2023

(54) DEVICES, SYSTEMS, FACILITIES AND PROCESSES FOR CO2 CAPTURE AT LIQUID NATURAL GAS FACILITIES WITH SELF GENERATED ELECTRIC POWER

(71) Applicant: NEXT CARBON SOLUTIONS, LLC, Houston, TX (US)

(72) Inventors: Ivan Van der Walt, Conroe, TX (US); Ben Heichelbech, Houston, TX (US); Connor Rivard, Houston, TX (US); Vikrum Subra, Houston, TX (US)

(21) Appl. No.: 18/120,323

(22) Filed: Mar. 10, 2023

Related U.S. Application Data
(60) Provisional application No. 63/318,978, filed on Mar. 11, 2022.

(51) Int. Cl. F25J 1/00; F01K 23/06

(52) U.S. Cl. CPC F25J 1/0022; F01K 23/064; F25J 2210/60; F25J 2220/66; F25J 2235/80

(57) ABSTRACT

Devices, systems, facilities, and processes for CO₂ capture at Liquid Natural Gas (LNG) facilities using self-generated electric power. The process includes a pretreatment unit located upstream of the power generating station and liquefaction facility to remove at least one of water, CO₂, or one or more heavy hydrocarbons. The CO₂ captured from the pretreatment unit, along with the CO₂ captured from the power generating station flue gas may be sent to a sequestration compressor, thereby reducing the overall emissions.

### CROSS REFERENCE TO RELATED APPLICATIONS

The present application claims priority to U.S. Provisional Application No. 63/318,978, filed on Mar. 11, 2022, the entire content of which is being incorporated herein by reference.

### BACKGROUND

Industrial facilities contribute to greenhouse gases through the various processes. Greenhouse gases comprise various gaseous components, such as carbon dioxide (CO₂), methane, nitrous oxide, hydrofluorocarbons, perfluorocarbons, and sulfur hexafluoride, which absorb radiation, trap heat in the atmosphere and generally contribute to undesirable environmental green-house effects.

Industrial facilities often implement certain forms of hydrocarbon reduction technologies such as scrubbers and flares. However, typically these facilities do not have a dedicated process specifically designed to reduce most greenhouse gas emissions as well as implement synergies to reduce the cost of direct air capture. The overall efficiency of industrial facilities usually suffers.

### SUMMARY

The present disclosure provides devices, systems, facilities and processes that enable industrial facilities to improve the overall efficiency of the facility and reduce greenhouse gas emissions.

In light of the disclosure herein, and without limiting the scope of the invention in any way, in a first aspect of the present disclosure, which may be combined with any other aspect listed herein unless specified otherwise, a facility may include well heads where pipeline gas is extracted to be sent to one or more gas gathering lines.

In a second aspect of the present disclosure, which may be combined with any other aspect listed herein unless specified otherwise, the pipeline gas may be collected from the one or more gas gathering lines and sent to a pretreatment unit to remove the CO₂, heavy hydrocarbons (such as C4+), and the saturated water from the pipeline gas. The CO₂ captured from this pretreatment unit may be sent to a separate compressor for sequestration. The heavy hydrocarbons may be separated and sent to storage.

In a third aspect of the present disclosure, which may be combined with any other aspect listed herein unless specified otherwise, the treated gas may be sent to an in-line compressor station to be compressed and sent to a power generating station. The pretreatment facility may be placed downstream of the in-line compressor station. The pretreatment facility can be located proximal to the compressor station and/or to a Liquid Natural Gas (LNG) facility.

In a fourth aspect of the present disclosure, which may be combined with any other aspect listed herein unless specified otherwise, the power generating station may include one or more gas turbines that can be used to power one or more liquefaction compressors at a liquefaction facility, and the one or more liquefaction compressors may be electric driven. The flue gas generated from the combustion of the pipeline gas in the one or more gas turbines may be sent to a carbon capture or post-combustion capture facility. The CO₂ rich stream from this carbon capture facility may be sent to a compressor to be sequestered. The compressor may be mechanically connected to the power generation gas turbines.

In a fifth aspect of the present disclosure, which may be combined with any other aspect listed herein unless specified otherwise, the power generated from the one or more gas turbines in the power generating station may be sent to the one or more electric driven compressors at the liquefaction facility.

In a sixth aspect of the present disclosure, which may be combined with any other aspect listed herein unless specified otherwise, the electric driven compressors may move the mixed refrigerant and propane used in the liquefaction process. The Liquefied Natural Gas (LNG) then may be sent to storage (such as one or more LNG storage tanks) and onward to ships. The boil off gas (BOG) generated from the one or more LNG storage tanks may be sent back to the treated gas stream at the inlet of the power generating station. The heat required for the carbon capture or post-combustion capture facility may be extracted from the steam produced by the power generating station. This heat can be used at any of or all of the units, stations, and/or facilities described above (post combustion capture facility, pretreatment facility, and liquefaction facility).

In some embodiments, a system may comprise a pretreatment unit located along a gas pipeline, the pretreatment facility is configured to separate at least one of water, CO₂, or one or more heavy hydrocarbons from a pipeline gas to produce a treated gas stream and a first CO₂ rich stream; an in-line compressor configured to transfer at least a portion of the treated gas stream to a power generating station; the power generating station configured to use the at least a portion of the treated gas stream to produce power through one or more gas turbines; a carbon capture unit configured to treat a flue gas generated from the one or more gas turbines of the power generating station to produce a second CO₂ rich stream; and a first sequestration compression unit configured to sequestrate at least one of the first CO₂ rich stream or the second CO₂ rich stream to produce a sequestrated CO₂ stream.

In some embodiments, the first sequestration compression unit may be further configured to convey the sequestrated CO₂ stream towards a first sequestration site.

In some embodiments, the in-line compressor may be further configured to transfer the remaining portion of the treated gas stream to the LNG facility to be liquefied.

In some embodiments, the system may further comprise a heavies removal unit located downstream of the pretreatment unit, and the heavies removal unit configured to remove the one or more heavy hydrocarbons from the pipeline gas after the pretreatment unit.

In some embodiments, the system may further comprise a storage unit located proximal to the pretreatment unit and configured to store the one or more heavy hydrocarbons separated from the pretreatment unit.

In some embodiments, the system may further comprise a second sequestration compressor located proximal to the pretreatment unit to sequestrate only the first CO₂ rich stream.

In some embodiments, the second sequestration compressor may be configured to transfer the sequestrated first CO₂ rich stream to a second sequestration site.

In some embodiments, the in-line compressor may comprise one or more gas turbines.

In some embodiments, the first sequestration compression unit may be mechanically connected to the one or more gas turbines.

In some embodiments, the system may further comprise a waste heat recovery unit configured to drive the one or more gas turbines and/or provide heat to at least one of the pretreatment unit or the carbon capture unit.

In some embodiments, the power generating station may be configured to produce an amount of power greater than that required by an LNG facility and export power to a neighboring electrical grid.

In some embodiments, the system may be configured to extract heat from a steam produced by the power generating station and use the extracted heat in at least one of the pretreatment unit, the carbon capture unit, or other LNG heat users, such as the removal of heavy hydrocarbons by the “heavies removal unit” or dehydration of the natural gas stream.

In some embodiments, the pretreatment unit may be proximal to the in-line compressor, upstream or downstream to the in-line compressor.

In some embodiments, the pretreatment unit may be proximal to the LNG facility.

In some embodiments, a process may comprise removing at least one of water, CO₂, or one or more heavy hydrocarbons from a pipeline gas to produce a treated gas stream and a first CO₂ rich stream; compressing the treated gas stream and transferring at least a portion of the compressed treated gas stream to a power generating station; using the at least a portion of the compressed treated gas stream to produce power through one or more gas turbines; treating a flue gas generated from the one or more gas turbines to produce a second CO₂ rich stream; and sequestrating at least one of the first CO₂ rich stream or the second CO₂ rich stream to produce a sequestrated CO₂ stream.

In some embodiments, the process may further comprise conveying the sequestrated CO₂ stream towards a sequestration site.

In some embodiments, the process may further comprise transferring the remaining portion of the compressed treated gas stream to an LNG facility and liquefying the remaining portion of the compressed treated gas stream.

### BRIEF DESCRIPTION OF THE FIGURES

Understanding that the figures depict only exemplary embodiments of the present disclosure and are not to be considered to be limiting the scope of the present disclosure, the present disclosure is described and explained with additional specificity and detail through the use of the accompanying figures. The figures are listed below.

FIG. 1 illustrates an exemplary schematic of a process according to some aspects of the present disclosure with the pretreatment facility located upstream of and proximal to the in-line compressor station that sends treated gas to a power generating station for self-generated power production. The generated power may be supplied to one or more electric driven compressors at a liquefaction facility.

FIG. 2 illustrates an exemplary schematic of a process according to some aspects of the present disclosure with the pretreatment facility located downstream of the in-line compressor station that sends treated gas to a power generating station for self-generated power production. This generated power may be supplied to one or more electric driven compressors at a liquefaction facility.

### DETAILED DESCRIPTION OF EXAMPLE EMBODIMENTS

The detailed description is to be construed as exemplary only and does not describe every possible embodiment, as describing every possible embodiment would be impractical, if not impossible. One of ordinary skill in the art could implement numerous alternate embodiments, which would still fall within the scope of the claims. Unless a term is expressly defined herein, there is no intent to limit the meaning of that term beyond its plain or ordinary meaning. To the extent that any term is referred to in a manner consistent with a single meaning, that is done for the sake of clarity only, and it is not intended that such term be limited to that single meaning.

As used in this disclosure and the appended claims, the singular forms “a,” “an” and “the” include plural referents unless the context clearly dictates otherwise. Thus, for example, reference to “a unit or “the unit” means “at least one unit” and includes two or more units.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the system, process, device, or component disclosed herein may lack any element that is not specifically disclosed herein. Thus, a disclosure of an embodiment using the term “comprising” includes a disclosure of embodiments “consisting essentially of′ and “consisting of” the components identified.

The terms “at least one of” and “and/or” used in the respective context of “at least one of X or Y” and “X and/or Y” should be interpreted as “X,” or “Y,” or “X and Y.” For example, “at least one of A or B” should be interpreted as “A without B,” or “B without A,” or “both A and B.”

Where used herein, the terms “example” and “such as,” particularly when followed by a listing of terms, are merely exemplary and illustrative and should not be deemed to be exclusive or comprehensive.

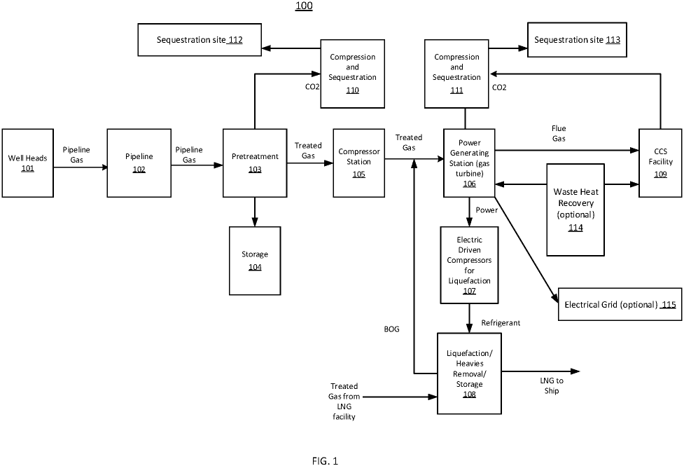

FIG. 1 illustrates an exemplary process with the pretreatment facility located upstream of the in-line compressor station that sends treated gas to a power generating station for self-generated power production 100 with the captured CO₂ being sent to sequestration/storage.

The raw gas may be collected from the well heads 101 and sent to one or more gas gathering lines. From the gas gathering lines, the gas may be transported to the main pipeline 102 and then sent further to a pretreatment unit 103.

The pretreatment unit 103 may be configured to remove at least one of water, CO₂, or one or more heavy hydrocarbons from the pipeline gas.

A heavies removal unit 108 may be located downstream of the pretreatment unit and configured to remove the one or more heavy hydrocarbons from the pipeline gas after the pretreatment unit.

The removed one or more heavy hydrocarbons may be sent to storage, such as one or more storage tanks 104. The CO₂ removed by and/or separated from the pretreatment unit 103 may be sent to a compression unit for compression and sequestration 110. The treated gas from the pretreatment unit 103 may be sent to an in-line compressor station 105 to be compressed. At least a portion of the compressed treated gas may be sent by and/or from the in-line compressor station 105 to the power generating station 106. The remaining compressed treated gas stream may be sent to an LNG facility to be liquefied.

The power generating station 106 may include one or more gas turbines which allow all the flue gas generated from the power generating station 106 to be collected in one location. The power generated from the power generating station 106 may be transmitted to one or more electric driven compressors 107 used to drive refrigerant for liquefaction in an LNG facility. The liquefaction and storage facility 108 may liquefy the treated gas from the LNG facility, then store the liquefied treated gas, and/or transport the liquefied treated gas by ship.

The boil off gas (BOG) generated from one or more LNG storage tanks at the liquefaction and storage facility 108 may be sent to and/or combined with the treated gas stream at the inlet of the power generating station 106 to be consumed by the one or more gas turbines at the power generating station 106.

The power generating station 106 may produce an amount of power greater than that required by an LNG facility and export power to a neighboring electrical grid 115.

The flue gas generated from the power generating station 106 may be sent to the carbon capture facility 109. At this facility, the CO₂ may be separated from the flue gas and sent to a compression unit for compression and sequestration 111. This compression unit 111 may or may not be the same compression and sequestration unit 110 as used to compress and sequestrate the CO₂ from the pretreatment facility 103. The compression and sequestration unit 110 and the compression unit 111 may convey the sequestrated CO₂ stream to the same sequestration site or different sequestration sites.

There may be a waste heat recovery unit 114 configured to drive the one or more gas turbines and/or provide heat to at least one of the pretreatment unit, the carbon capture unit, or other LNG heat users, such as the removal of heavy hydrocarbons by the “heavies removal unit” or dehydration of the natural gas stream. The waste heat recovery unit may be a heat exchanger configured to transfer heat energy from the flue gas stream into a heat medium (usually hot oil or steam).

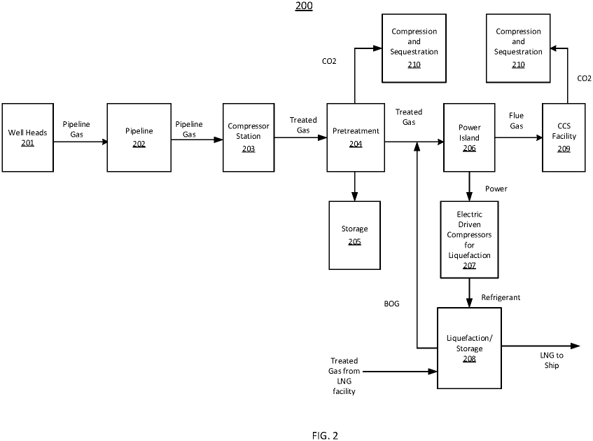

FIG. 2 illustrates an exemplary process with the pretreatment facility located downstream of the in-line compressor station that sends the treated gas to a power generating station for self-generated power production 200 with the captured CO₂ being sent to sequestration/storage.

The raw gas may be collected from the well heads 201 and sent to one or more gas gathering lines. From the one or more gathering lines, the gas may be transported to the main pipeline 202 and then sent to an in-line compressor station 203. From the in-line compressor station 203, the pipeline gas may be sent further to a pretreatment unit 204. The pretreatment unit 204 may be configured to remove at least one of water, CO₂, or one or more heavy hydrocarbons from the pipeline gas.

A heavies removal unit 208 may be located downstream of the pretreatment unit and configured to remove the one or more heavy hydrocarbons from the pipeline gas after the pretreatment unit.

The removed one or more heavy hydrocarbons may be sent to storage, such as one or more storage tanks 205. The CO₂ separated from and/or removed by the pretreatment unit 204 may be sent to a compression unit for compression and sequestration 210. The treated gas from the pretreatment unit 204 may be sent to the power generating station 206, which may include one or more gas turbines to allow all the flue gas generated from the power generating station 206 to be collected in one location.

The power generated from the power generating station 206 may be transmitted to one or more electric driven compressors 207 used to drive refrigerant for liquefaction in an LNG facility. The liquefaction and storage facility 208 may liquefy the treated gas from the LNG facility, then store the liquefied treated gas, and/or transport the liquefied treated gas by ship.

The BOG generated from the LNG storage tanks at the liquefaction and storage facility 208 may be sent to and/or combined with the treated gas stream at the inlet of the power generating station 206 to be consumed by the one or more gas turbines.

The power generating station 106 may produce an amount of power greater than that required by an LNG facility and export power to a neighboring electrical grid 215.

The flue gas from the power generating station 206 may be sent to the carbon capture facility 209. At this facility, the CO₂ may be separated from the flue gas and sent to a compression unit for compression and sequestration 211. This compression unit 211 may or may not be the same compression and sequestration unit 210 as used to compress and sequester the CO₂ from the pretreatment facility 203. The compression and sequestration unit 210 and the compression unit 211 may convey the sequestrated CO₂ stream to the same sequestration site or different sequestration sites.

There may be a waste heat recovery unit configured to drive the one or more gas turbines and/or provide heat to at least one of the pretreatment unit, the carbon capture unit, or other LNG heat users, such as the removal of heavy hydrocarbons by the “heavies removal unit” or dehydration of the natural gas stream . The waste heat recovery unit may be a heat exchanger configured to transfer heat energy from the flue gas stream into a heat medium (usually hot oil or steam).

1. A system comprising:
a pretreatment unit located along a gas pipeline, the pretreatment facility is configured to separate at least one of water, CO₂, or one or more heavy hydrocarbons from a pipeline gas to produce a treated gas stream and a first CO₂ rich stream;
an in-line compressor configured to compress the treated gas stream and transfer at least a portion of the compressed treated gas stream to a power generating station;
the power generating station configured to use the at least a portion of the compressed treated gas stream to produce power through one or more gas turbines;
a carbon capture unit configured to treat a flue gas generated from the one or more gas turbines of the power generating station to produce a second CO₂ rich stream; and
a first sequestration compression unit configured to sequestrate at least one of the first CO₂ rich stream or the second CO₂ rich stream to produce a sequestrated CO₂ stream.

2. The system of claim 1, wherein the first sequestration compression unit is further configured to convey the sequestrated CO₂ stream towards a first sequestration site.

3. The system of claim 1, wherein the in-line compressor is further configured to transfer the remaining portion of the compressed treated gas stream to an LNG facility to be liquefied.

4. The system of claim 1 further comprising a heavies removal unit located downstream of the pretreatment unit, and the heavies removal unit configured to remove the one or more heavy hydrocarbons from the pipeline gas after the pretreatment unit.

5. The system of claim 1 further comprising a storage unit located proximal to the pretreatment unit and configured to store the one or more heavy hydrocarbons separated from the pretreatment unit.

6. The system of claim 1 further comprising a second sequestration compressor located proximal to the pretreatment unit to sequestrate only the first CO₂ rich stream.

7. The system of claim 6, wherein the second sequestration compressor is configured to transfer the sequestrated first CO₂ rich stream to a second sequestration site.

8. The system of claim 1, wherein the in-line compressor comprises one or more gas turbines.

9. The system of claim 8, wherein the first sequestration compression unit is mechanically connected to the one or more gas turbines.

10. The system of claim 8 further comprising a waste heat recovery unit configured to drive the one or more gas turbines and/or provide heat to at least one of the pretreatment unit, the carbon capture unit, a dehydration unit, or a heavies removal unit.

11. The system of claim 1, wherein the power generating station is configured to produce an amount of power greater than that required by an LNG facility and export power to a neighboring electrical grid.

12. The system of claim 1, wherein the system is configured to extract heat from a steam produced by the power generating station and use the extracted heat in at least one of the pretreatment unit, the carbon capture unit, a dehydration unit, or a heavies removal unit.

13. The system of claim 1, wherein the pretreatment unit is proximal to the in-line compressor.

14. The system of claim 1, wherein the pretreatment unit is proximal to the LNG facility.

15. A process comprising:
removing at least one of water, CO₂, or one or more heavy hydrocarbons from a pipeline gas to produce a treated gas stream and a first CO₂ rich stream;
compressing the treated gas stream and transferring at least a portion of the compressed treated gas stream to a power generating station;
using the at least a portion of the compressed treated gas stream to produce power through one or more gas turbines;
treating a flue gas generated from the one or more gas turbines to produce a second CO₂ rich stream; and
sequestrating at least one of the first CO₂ rich stream or the second CO₂ rich stream to produce a sequestrated CO₂ stream.

16. The process of claim 15 further comprising conveying the sequestrated CO₂ stream towards a sequestration site.

17. The process of claim 15 further comprising transferring the remaining portion of the compressed treated gas stream to an LNG facility and liquefying the remaining portion of the compressed treated gas stream.
